(19) United States
(12) Patent Application Publication
(10) Pub. No.: US 2013/0250572 A1
(43) Pub. Date: Sep. 26, 2013

(54) LIGHTING APPARATUS

(71) Applicant: DELTA ELECTRONICS, INC., Kuei San (TW)

(72) Inventors: Hsuan-Hsi CHANG, Kuei San (TW); Chun-Min HUANG, Kuei San (TW); Shih-Peng CHEN, Kuei San (TW); Ching-Chuan SHIUE, Kuei San (TW); Li-Fan LIN, Kuei San (TW); Wen-Chia LIAO, Kuei San (TW)

(73) Assignee: DELTA ELECTRONICS, INC., Kuei San (TW)

(21) Appl. No.: 13/848,300

(22) Filed: Mar. 21, 2013

(30) Foreign Application Priority Data
Mar. 21, 2012 (TW) 101109659

(51) Int. Cl. F21V 7/00

(52) U.S. Cl. CPC F21V 7/00
USPC 362/235

(57) ABSTRACT

A lighting apparatus includes a circuit board, a plurality of light-emitting diode (LED) units and an optical element. The optical element is transflective. The LED units and the optical element are disposed on the circuit board. The optical element has at least one reflective surface so that lights emitted from the LED units to the optical element partially penetrate through and are partially reflected by the optical element.

### CROSS REFERENCE TO RELATED APPLICATIONS

This Non-provisional application claims priority under 35 U.S.C. §119(a) on Patent Application No(s). 101109659 filed in Taiwan, Republic of China on Mar. 21, 2012, the entire contents of which are hereby incorporated by reference.

### BACKGROUND OF THE INVENTION

1. Field of Invention

The present invention relates to a lighting apparatus and, in particular, to a lighting apparatus that is transflective.

2. Related Art

As the progressive of technology, the lighting apparatus has become one of the indispensable devices in our life. The lighting apparatus is initially composed of a tungsten bulb but now a light-emitting diode (LED). LED has the advantages of lower power consumption, smaller size and higher brightness.

FIG. 1 is a schematic diagram of a conventional lighting apparatus 1. The lighting apparatus 1 include a LED unit 11 and a light-guiding rod 12 for guiding the light beam along the arrow direction. The light-guiding rod 12 is a solid light-permeable structure and has a reflective surface 121. When the light-guiding rod 12 is configured on the light path of the LED unit 11, the light beam emitted from the LED unit 11 will be reflected by the reflective surface 121 of the light-guiding rod 12 and then outputted.

Unfortunately, the optical property of the light-guiding rod 12 will trap the light of the LED unit 11 inside the light-guiding rod 12 and thus cause some energy loss. Thus, the emitted light can not be fully used. Although the reflective surface 121 can reflect the light beam to slightly increase the light output quantity, the energy loss in the light-guiding rod 12 can not be recovered so that the final light output quantity can not be sufficiently improved.

Besides, the light irradiation range of the LED unit 11 is smaller, so the indoor light brightness may be insufficient. In order to increase the light intensity of the LED unit 11 to reach the requirement for indoor illumination, the lighting efficiency will be sacrificed and thus worse than the convention fluorescent lamp (or higher power consumption than the fluorescent lamp). Moreover, in order to improve the issue of small light irradiation range, which causes the poor indoor light brightness, the amount of the installed lighting apparatuses must be increased. However, the additional lighting apparatuses will increase the hardware cost, maintaining cost, and energy cost.

### SUMMARY OF THE INVENTION

In view of the foregoing, an objective of the present invention is to provide a transflective lighting apparatus so that the emitted light of the lighting apparatus has higher efficiency and larger lighting angle.

To achieve the above objective, the present invention discloses a lighting apparatus including a circuit board, a plurality of light-emitting diode (LED) units and an optical element. The optical element is transflective. The LED units and the optical element are disposed on the circuit board. The optical element has at least one reflective, surface so that lights emitted from the LED units to the optical element partially penetrate through and are partially reflected by the optical element.

In one embodiment of the invention, the optical element is made of a transparent material; otherwise, the optical element is made of an opaque material and has at least an opening. The opening allows the optical element to be transflective.

In one embodiment of the invention, the reflective surface comprises at least a planar surface, at least a curved surface, or their combination. The reflective surface is composed of one or more planar and/or curved surfaces. In practice, the reflective surface may have different combination aspects composed of, for example, a single planar surface, a single curved surface, multiple planar surfaces, multiple curved surfaces, one planar surface and one curved surface, one planar surface and multiple curved surfaces, one curved surface and multiple planar surfaces, or multiple planar surfaces and multiple curved surfaces.

In one embodiment of the invention, all or a part of the reflective surface is a smooth surface, a rough surface, or their combination. In practice, the reflective surface can be an entirely smooth surface, a partial smooth surface, an entirely rough surface, a partial rough surface, or a partial smooth and partial rough surface.

In one embodiment of the invention, the lighting apparatus further comprises a lamp base electrically connected to the circuit board.

In one embodiment of the invention, the lighting apparatus further comprises a lampshade connected to a periphery of the lamp base for covering the LED units and the optical element. The lampshade comprises a fluorescent material. In practice, the lampshade is doped with fluorescent powders for modulating the color of the light emitted from the LED units.

In one embodiment of the invention, the angle between a refracted light and a reflected light through the optical element is larger than 120°.

In one embodiment of the invention, the optical element is located on a geometrical center of the LED units.

In one embodiment of the invention, the LED units are correspondingly disposed adjacent to a periphery of the optical element along a protection direction.

In one embodiment of the invention, the LED units emit different color lights.

In one embodiment of the invention, the LED units are regularly or irregularly arranged.

In one embodiment of the invention, each of the LED units comprises at least a LED die or at least a LED package.

To achieve the above objective, the present invention also discloses a lighting apparatus, including a circuit board, a plurality of LED units, a lamp base, a lampshade and an optical element. The LED units are disposed on the circuit board. The amp base is electrically connected to the circuit board. The lampshade is connected to a periphery of the lamp base for covering the LED units. The optical element is transflective and is connected to the lampshade. The optical element has at least one reflective surface so that lights emitted from the LED units to the optical element partially penetrate through and are partially reflected by the optical element.

As mentioned above, the lighting apparatus of the invention includes an optical element, which has a reflective surface and is transflective. The optical element is disposed on the circuit board, so that the lights emitted from the LED units partially penetrate through and are partially reflected by the optical element. Accordingly, the overall lights emitted from the LED units can be more efficiently utilized, thereby reducing the light loss and increasing the light quantity of the lighting apparatus. The light transmission and reflection depend on some conditions such as the material, opening, surface shape, roughness of the reflective surface, and the positions of the optical element and the LED units, so the lighting apparatus of the invention can be properly designed to make the light reach the maximum angle after reflected by the optical element. This design can improve the issue of small light irradiation range and increase the indoor brightness, so that the total configured amount of the lighting apparatuses can be decreased.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram of a conventional lighting apparatus;

FIGS. 2A and 2B are schematic diagrams showing the structure of the lighting apparatus of the invention;

FIGS. 3A and 3B are schematic diagrams showing the optical element with an opening of the lighting apparatus of the invention;

FIGS. 4A to 4F are schematic diagrams showing various optical elements of the lighting apparatus of the invention;

FIG. 5A is a schematic diagram showing a circuit board of the lighting apparatus of the invention, wherein the circuit board is electrically connected to the lamp base;

FIG. 5B is a schematic diagram showing a lampshade of the lighting apparatus of the invention, wherein the lampshade is connected to the lamp base; and

FIG. 6 is a schematic diagram showing another optical element of the lighting apparatus of the invention.

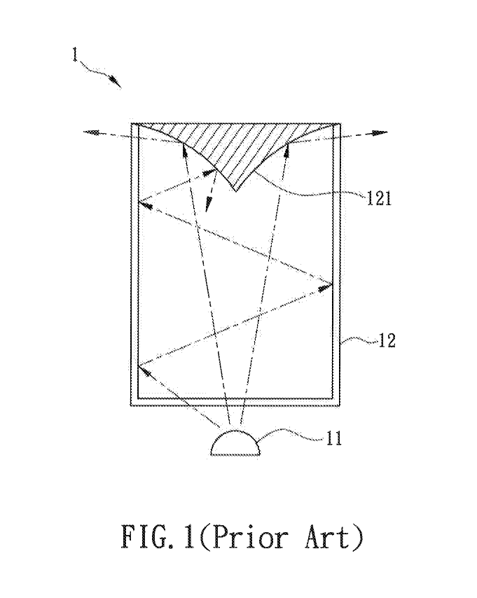

### DETAILED DESCRIPTION OF THE INVENTION

The present invention will be apparent from the following detailed description, which proceeds with reference to the accompanying drawings, wherein the same references relate to the same elements.

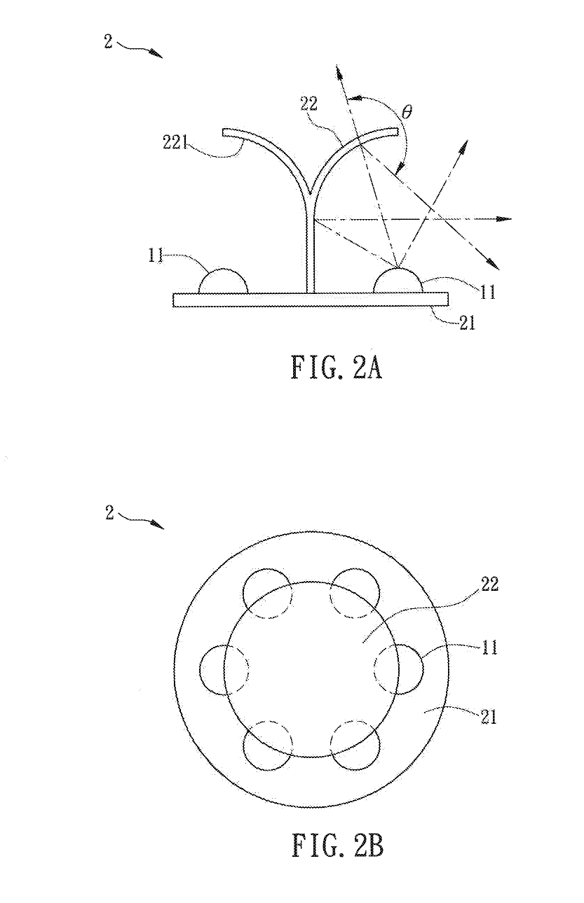

FIG. 2A is a schematic diagram showing the structure of a lighting apparatus 2 of the invention. The lighting apparatus 2 includes a plurality of LED units 11, which are disposed on the circuit board 21 and configured for emitting light. The LED unit 11 includes at least one LED die or at least one LED package. The lighting apparatus 2 also includes an optical element 22, which is transflective and is disposed on the circuit board 21. The optical element 22 has at least one reflective surface 221 so that tights emitted from the LED units 11 to the optical element 22 partially penetrate through and are partially reflected by the optical element 22. The WI w “transflective” means that a part of the lights emitted from the LED units 11 to the optical element 22 can directly pass through the optical element 22 (refracted light), and the residual part thereof is reflected by the optical element 22 (reflected light). The angle θbetween the refracted light and the reflected light is larger than 120°.

The optical element 22 is made of a transparent material such as glass, acrylic, resin, plastic, or the likes. Alternatively, the optical element 22 may be made of an opaque material and include at least one opening for achieving the same transflective effect. The opaque material is, for example but not limited to, a metal material or a non-metal material with a reflective surface/layer.

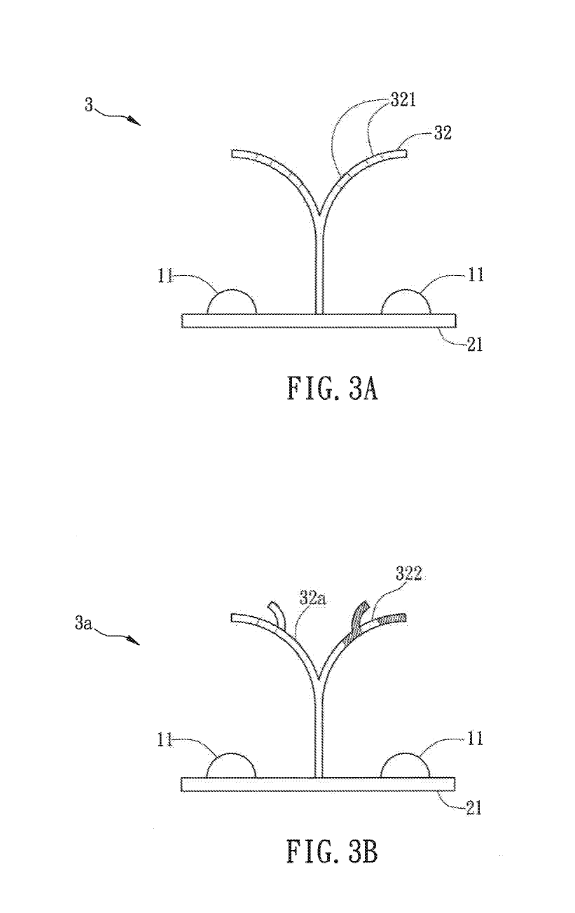

FIGS. 3A and 3B are schematic diagrams showing the optical element with an opening of the lighting apparatus of the invention. Herein, the optical elements 32 and 32a are made of opaque materials, and the light emitted from the LED units 11 can pass through the opening of the optical element 32 or 32a. The opening can he a trench (not shown) or a hole, such as a through hole 321 shown in FIG. 3A or a half hole 322 shown in FIG. 3B. The term “half hole” is formed by drilling the optical element and remaining the material of the drilled part, wherein the remained material is partially connected to the edge of the hole. When the optical element 32 or 32a is configured with many openings, the sizes and shapes of the openings and the intervals between the openings can be the same or different.

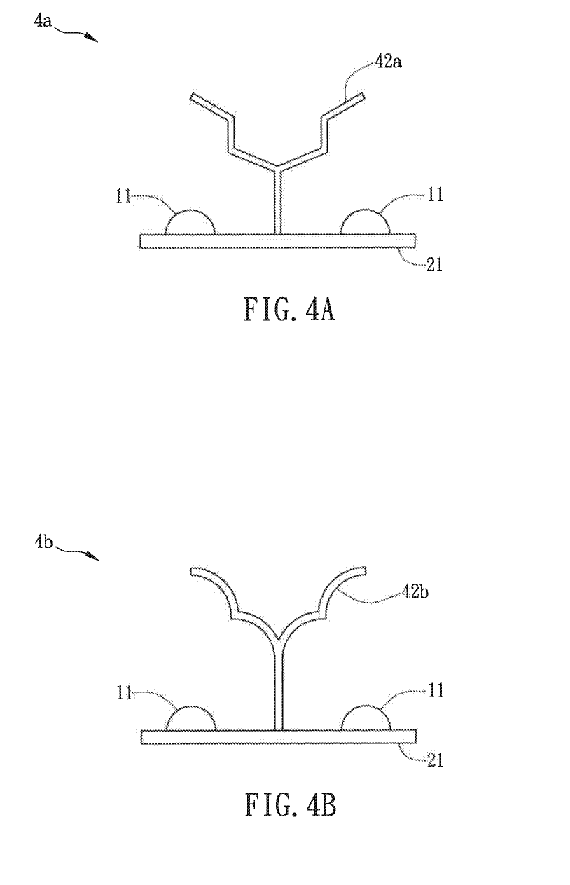

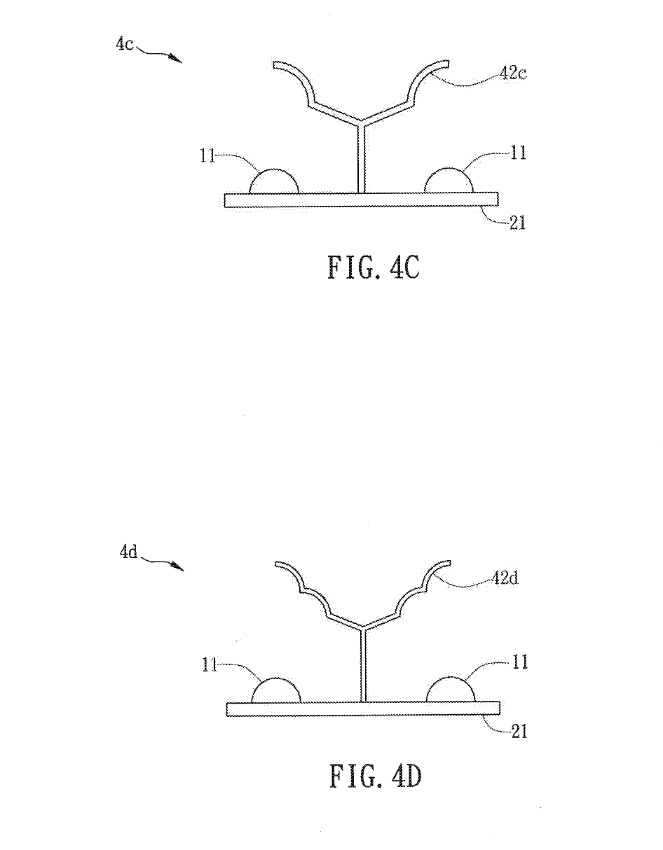

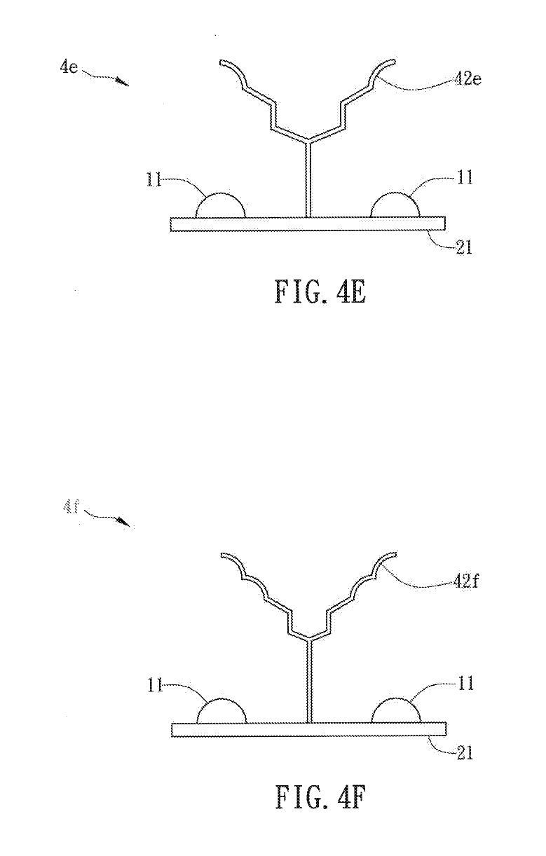

FIGS. 4A to 4F are schematic diagrams showing various optical elements of the lighting apparatus of the invention. The reflective surface of the optical element is composed of at least one planar surface, at least one curved surface, or their combinations. In the lighting apparatus 4a shown in FIG. 4A, the reflective surface of the optical element 42a includes a plurality of planar surfaces. In the lighting apparatus 4b shown in FIG. 4B, the reflective surface of the optical element 42b includes a plurality of curved surfaces. In the lighting apparatus 4c shown in FIG. 4C, the reflective surface of the optical element 42c includes one planar surface and one curved surface, In the lighting apparatus 4d shown in FIG. 4D, the reflective surface of the optical element 42d includes one planar surface and a plurality of curved surfaces. In the lighting apparatus 4e shown in FIG. 4E, the reflective surface of the optical element 42e includes one curved surface and a plurality of planar surfaces. In the lighting apparatus 4f shown in FIG. 4F, the reflective surface of the optical element 42f includes a plurality of planar surfaces and a plurality of curved surfaces. Those skilled in the art should know that the reflective surface can be carried out by any available way and not limited to the above aspects.

For example, the reflective surface may include entirely smooth surfaces, partially smooth surfaces, entirely rough surfaces, partially rough surfaces, or partially smooth and partially rough surfaces.

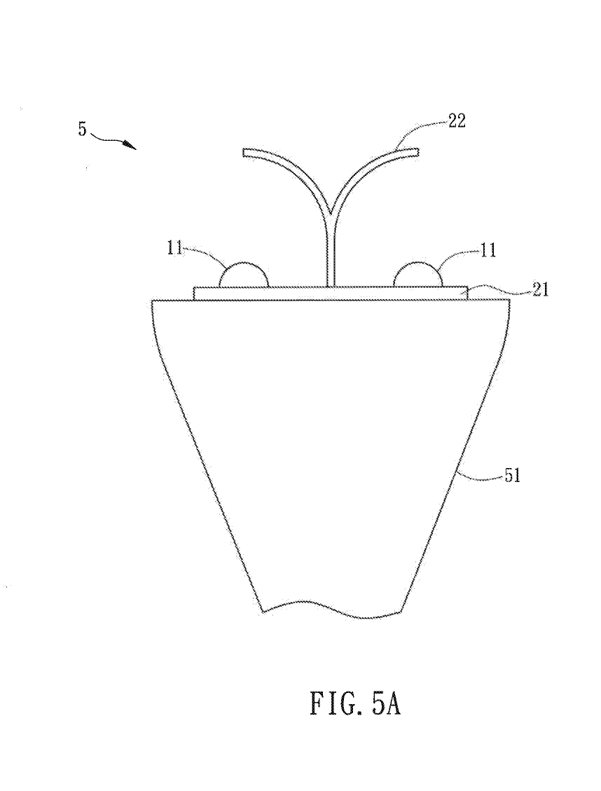

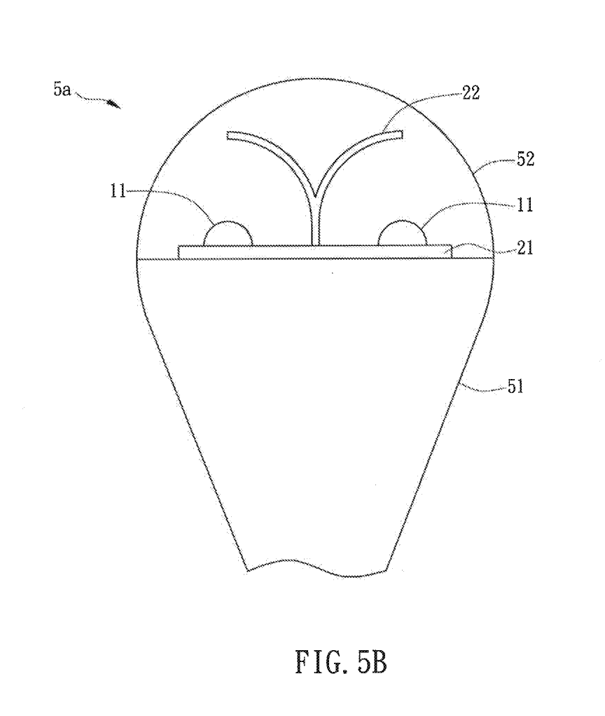

FIG. 5A is a schematic diagram showing a circuit board 21 of the lighting apparatus 5 of the invention, wherein the circuit board 21 is electrically connected to a lamp base 51. In this embodiment, the lighting apparatus 5 further includes a lamp base 51, and a power source assembly is configured inside the lamp base 51 for providing power to the LED units 11 disposed on the circuit board 21.

FIG. 5B is a schematic diagram showing a lampshade 52 of the lighting apparatus 5a of the invention, wherein the lampshade 52 is connected to the lamp base 51. In this embodiment, the lighting apparatus 5a further includes a lampshade 52 connected to the periphery of the lamp base 51. The lampshade 52 covers the LED units 11 and the optical element 22 to prevent the undesired damage caused by dusts or external forces. The material of the lampshade 52 may include a fluorescent material for changing or modulating the color of the lights emitted from the LED units 11. Alternatively, the LED units 11 can emit different color lights.

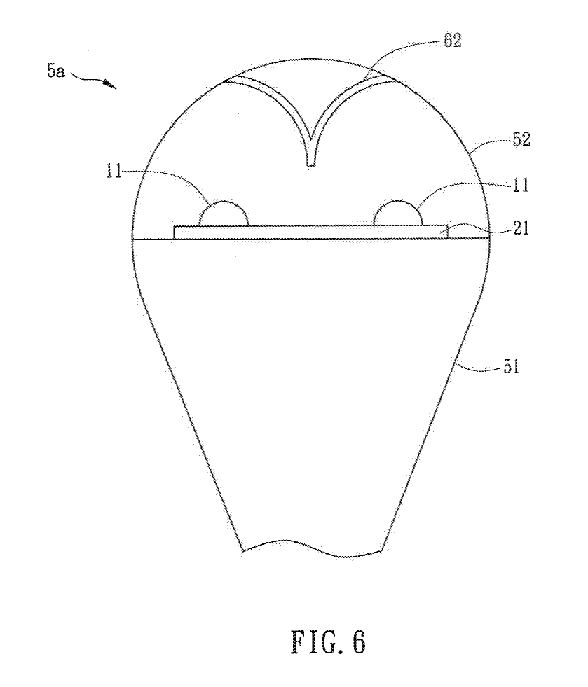

FIG. 6 is a schematic diagram showing another optical element of the lighting apparatus of the invention. Different from those of FIG. 5B, the lighting apparatus shown in FIG. 6 includes an optical element 62, which is connected to the lampshade 52 instead of the circuit board 21.

The LED units 11 are regularly arranged in, for example, annular configuration, concentric-circle configuration, array configuration, slant-array configuration, or the likes. Otherwise, the LED units 11 can be irregularly arranged in, for example, random configuration, scattered configuration, or the likes. In addition, the LED units 11 can be partially or totally arranged in high-low density on the circuit board 21 according to the requirement for light output intensity. For example, the area requiring higher light output intensity is corresponding to higher density of LED units 11 on the circuit board 21; otherwise, the area requiring lower light output intensity is corresponding to lower density of LED units 11 on the circuit board 21.

Regardless of the arrangement of LED units 11, as shown in FIG. 2B, the optical element 22 is disposed at the geometric center of the LED units 11. Besides, the LED units 11 are correspondingly disposed adjacent to a periphery of the optical element 22 along a protection direction of the optical element 22. In more detailed, on the projection direction of the optical element 22, the periphery of the optical element 22 passes through the LED units 11. The positions of the LED units 11 are distributed within a certain range around the periphery of the optical element 22.

In summary, the lighting apparatus of the invention includes an optical element, which has a reflective surface and is transflective. The optical element is disposed on the circuit hoard, so that the lights emitted from the LED units partially penetrate through and are partially reflected by the optical element. Accordingly, the overall lights emitted from the LED units can be more efficiently utilized, thereby reducing the light loss and increasing the light quantity of the lighting apparatus. The light transmission and reflection depend on some conditions such as the material, opening, surface shape, roughness of the reflective surface, and the positions of the optical element and the LED units, so the lighting apparatus of the invention can be properly designed to make the light reach the maximum angle after reflected by the optical element. This design can improve the issue of small light irradiation range and increase the indoor brightness, so that the total configured amount of the lighting apparatuses can be decreased.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A lighting apparatus comprising:
a circuit board;
a plurality of light-emitting diode (LED) units disposed on the circuit board; and
an optical element, which is transflective and disposed on the circuit board, wherein the optical element has at least one reflective surface so that lights emitted from the LED units to the optical element partially penetrate through and are partially reflected by the optical element.

2. The lighting apparatus of claim 1, wherein the optical clement is made of a transparent material.

3. The lighting apparatus of claim 1, wherein the optical element is made of an opaque material and has at least an opening.

4. The lighting apparatus of claim 1, wherein the reflective surface comprises at least a planar surface or curved surface.

5. The lighting apparatus of claim 1, wherein all or a part of the reflective surface is a smooth or rough surface.

6. The lighting apparatus of claim 1, further comprising;
a lamp base electrically connected to the circuit board.

7. The lighting apparatus of claim 6, further comprising:
a lampshade connected to a periphery, of the lamp base for covering the LED units and the optical element.

8. The lighting apparatus of claim 7, wherein the lampshade comprises a fluorescent material.

9. The lighting apparatus of claim 1, wherein the angle between a refracted light and a reflected light through the optical element is larger than 120°.

10. The lighting apparatus of claim 1, wherein the optical element is located on a geometrical center of the LED units.

11. The lighting apparatus of claim 1, wherein the LED units are correspondingly disposed adjacent to a periphery of the optical element along a protection direction.

12. The lighting apparatus of claim 1, wherein each of the LED units comprises at least a LED die or at least a LED package.

13. A lighting apparatus comprising:
a circuit board;
a plurality of light-emitting diode (LED) units disposed on e circuit board;
a lamp base electrically connected to the circuit board;
a lampshade connected to a periphery of the lamp base for covering the LED units; and
an optical element, which is transflective and is connected to the lampshade, wherein the optical element has at least one reflective surface so that lights emitted from the LED units to the optical element partially penetrate through and are partially reflected by the optical element.
